(19) United States
(12) Patent Application Publication
(10) Pub. No.: US 2008/0284501 A1
(43) Pub. Date: Nov. 20, 2008

(54) REFERENCE BIAS CIRCUIT FOR COMPENSATING FOR PROCESS VARIATION

(75) Inventor: Hyung-Seuk KIM, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 12/121,519

(22) Filed: May 15, 2008

(30) Foreign Application Priority Data
May 16, 2007 (KR) 2007-0047672

(51) Int. Cl. G05F 3/02

(52) U.S. Cl. 327/538

(57) ABSTRACT

A reference bias circuit is provided. The reference bias circuit includes a voltage detector, an operational amplifier, a compensation circuit, and a reference current generator. The voltage detector detects a first input voltage and a second input voltage of the operational amplifier based on a voltage of a first node and a voltage of a second node. The voltage of the first and second nodes varies with temperature, which changes the first input voltage and the second input voltage and thus changes the output voltage of the operational amplifier. The compensation circuit compensates for the variation of the voltage of the first and second nodes caused by temperature and/or process variation, thereby preventing the variation of a reference current generated by the reference current generator based on the output voltage of the operational amplifier.

### CROSS-REFERENCE TO RELATED PATENT APPLICATION

This application claims the benefit of Korean Patent Application No. 10-2007-0047672, filed on May 16, 2007, in the Korean Intellectual Property Office, the disclosure of which is incorporated herein in its entirety by reference.

### FIELD OF THE INVENTION

The present invention relates to a reference bias circuit, and more particularly, to a reference bias circuit for compensating a reference current or voltage variation caused by a process variation.

### BACKGROUND OF THE INVENTION

Reference bias circuits (e.g., bandgap circuits) are widely used to provide a constant reference current or voltage without being influenced by power supply voltage variation, temperature change, and process variation.

FIG. 1 illustrates a conventional reference bias circuit 100. The reference bias circuit 100 is a bandgap circuit and is disclosed in references [H. Banba, “A CMOS bandgap reference circuit with sub-1-V operation”, IEEE J. Solid State Circuits, vol. 34, pp. 670-674, May 1999] and [K. N. Leung, “A sub-1-V 15-ppm/C CMOS bandgap voltage reference without low threshold voltage device”, IEEE J. Solid State Circuits, vol. 37, pp. 526-530, April 2002]

In the reference bias circuit 100, voltages VD1 and VD2, which are detected by diodes D1 and D2, respectively, are divided by resistances and divided voltages V+ and V− are supplied to a positive (+) input terminal and a negative (−) input terminal, respectively, of an operational amplifier 102. The characteristics of the diodes D1 and D2 (e.g., voltage at two ends of each diode, which is referred to as “diode voltage”) may vary with a process variation. For example, diodes may be divided into diodes having a low diode voltage (hereinafter, referred to as “low diode voltage models) and diodes having a high diode voltage (hereinafter, referred to as “high diode voltage models) according to a process variation. In addition, the low diode voltage models and the high diode voltage models may have different diode voltage variations according to temperature.

FIG. 2 is a graph illustrating the changes in diode voltage according to the temperature of the diode D1 or D2 illustrated in FIG. 1. Particularly, the graph shows diode voltage while constant current is supplied to the diode D1 or D2. In FIG. 2, a dotted line indicates the diode voltage of a high diode voltage model and a solid line indicates the diode voltage of a low diode voltage model.

Referring to FIG. 2, each of the diodes D1 and D2 may have different diode voltages according to process variation and diode voltage variation may vary with the temperature. Accordingly, in a case where the voltages V+ and V− at the input terminals of the operational amplifier 102 in the reference bias circuit 100 are optimized so as to operate responsive to the diode voltage of a particular diode model (e.g., a low diode voltage model), if a diode voltage divided by a different diode model (e.g., a high diode voltage model) is supplied to the operational amplifier 102, the reference bias circuit 100 may not be able operate normally. Then, reference current Iref generated responsive to an output voltage of the operational amplifier 102 may change.

FIG. 3A is a graph illustrating the changes in the reference current Iref according to the temperature of different diode models when the reference bias circuit 100 illustrated in FIG. 1 is optimized to a low diode voltage model. In FIGS. 3A through 3C, a dotted line indicates the reference current Iref with respect to a high diode voltage model and a solid line indicates the reference current Iref with respect to a low diode voltage model. Referring to FIG. 3A, with respect to the high diode voltage model, the reference current Iref suddenly drops at a temperature of less than T1, and therefore, a difference in the reference current Iref between the different diode models remarkably increases at a temperature of greater than T1.

FIG. 3B is a graph illustrating the changes in the reference current Iref according to the temperature of different diode models when the reference bias circuit 100 illustrated in FIG. 1 is optimized to a high diode voltage model. Referring to FIG. 3B, with respect to a low diode voltage model, the reference current Iref suddenly drops at a temperature of greater than T2, and therefore, a difference in the reference current Iref between the different diode models remarkably increases at the temperature of greater than T2.

FIG. 3C is a graph illustrating the changes in the reference current Iref according to the temperature of different diode models when the reference bias circuit 100 illustrated in FIG. 1 is set to prevent the reference current Iref from dropping. Referring to FIG. 3C, a difference in the reference current Iref between the different diode models is maintained substantially constant. As illustrated in FIGS. 3A through 3C, the difference in the reference current Iref may be several tens of μA according to the different diode models.

As described above, the conventional reference bias circuit 100 may not operate normally because of diode models having different diode voltages due to process variation. In other words, since the voltage characteristics of diodes may vary with process variation, the output (current or voltage) of a reference bias circuit (e.g., a reference current circuit or a reference voltage circuit) using diodes may also vary.

### SUMMARY OF THE INVENTION

Some embodiments of the present invention provide a reference bias circuit having low dependence on temperature and process variation by compensating for a diode voltage variation caused by the temperature and process variation.

According to some embodiments of the present invention, there is provided a reference bias circuit including a current mirror, a voltage detector, an operation amplifier, and a compensation circuit. The current mirror may include a pair of first-conductivity-type transistors which are connected among a power supply voltage line, a first node, and a second node and have a common gate.

The voltage detector may be connected among the first node, the second node, and a ground voltage line and may generate a first input voltage and a second input voltage based on a voltage level of the first node and a voltage level of the second node, respectively. The operational amplifier may include a first input terminal to receive the first input voltage, a second input terminal to receive the second input voltage, and an output terminal connected to the common gate of the pair of the transistors.

The compensation circuit compensates for a voltage variation of the first node responsive to a control signal generated based on a voltage of the first node. The compensation circuit may generate the control signal by detecting the voltage of the first node and stepping down the first node voltage and compensate for the voltage variation of the first node responsive to the control signal. In addition, the compensation circuit may detect the voltage of the first node, output the control signal based on a result of comparing the detected first node voltage with a predefined voltage, and compensate for the voltage variation of the first node responsive to the control signal.

The voltage variation of the first node may be caused by temperature and/or process variation. The compensation circuit may further include a dummy control signal generator which is connected to the second node and functions as a load on the second node to balance a load between the first node and the second node. The reference bias circuit may further include a reference current generator configured to generate a reference current responsive to an output voltage of the operational amplifier.

According to other embodiments of the present invention, there is provided a reference bias circuit including a current mirror, a voltage detector, an operation amplifier, and a compensation circuit. The current mirror is connected among a power supply voltage line, a first node, and a second node. The voltage detector outputs a first input voltage and a second input voltage by dividing a voltage of the first node and a voltage of the second node by a plurality of resistors. The operational amplifier amplifies a difference between the first input voltage and the second input voltage and outputs the result of the amplification to the current mirror. The compensation circuit compensates for a voltage variation of the first node by varying a resistance value of at least one pair of resistors among the plurality of resistors responsive to a control signal generated based on the voltage of the first node.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional reference bias circuit;

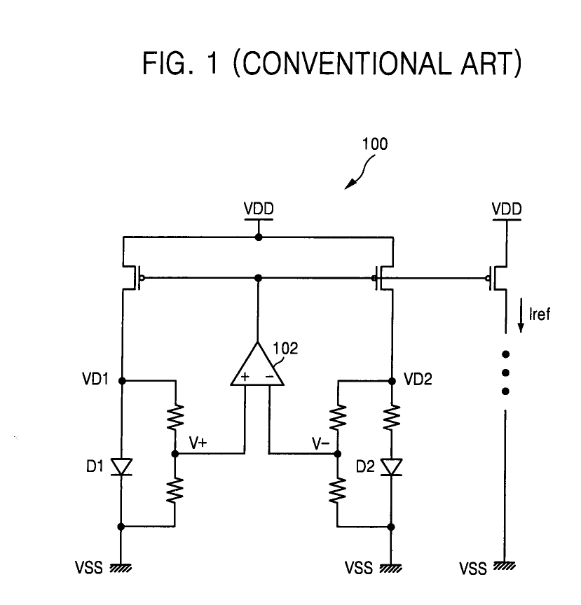

FIG. 2 is a graph illustrating the changes in diode voltage according to the temperature of a diode illustrated in FIG. 1;

FIG. 3A is a graph illustrating the changes in reference current according to the temperature of different diode models when the reference bias circuit illustrated in FIG. 1 is optimized to a low diode voltage model;

FIG. 3B is a graph illustrating the changes in reference current according to the temperature of different diode models when the reference bias circuit illustrated in FIG. 1 is optimized to a high diode voltage model;

FIG. 3C is a graph illustrating the changes in reference current according to the temperature of different diode models when the reference bias circuit illustrated in FIG. 1 is set to prevent the reference current from dropping;

FIG. 4 illustrates a reference bias circuit according to some embodiments of the present invention; and

FIG. 5 is a graph of reference current generated in a reference voltage generation circuit illustrated in FIG. 4 versus temperature with respect to different diode models.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

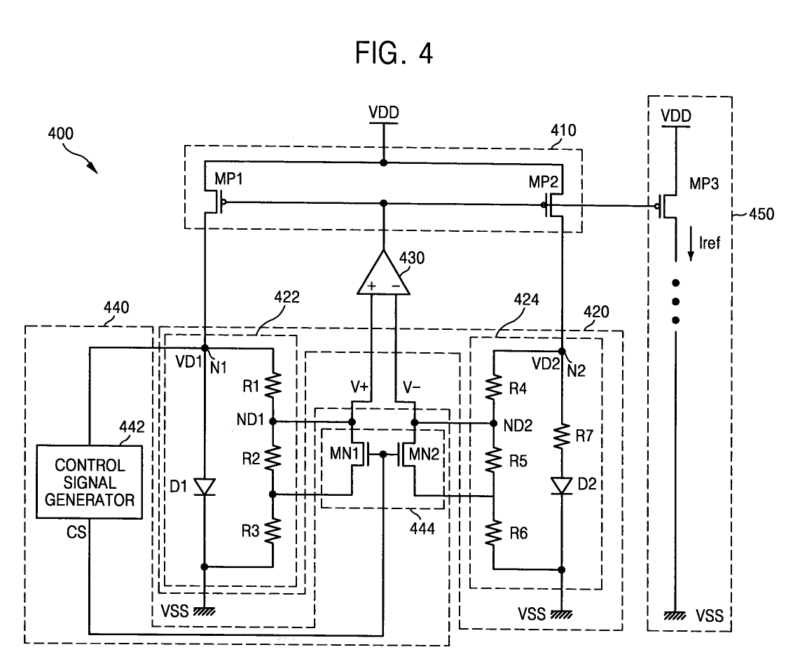

FIG. 4 illustrates a reference bias circuit 400 according to some embodiments of the present invention. The reference bias circuit 400 is a reference current generation circuit for generating a reference current Iref. Referring to FIG. 4, the reference bias circuit 400 includes a current mirror 410, a voltage detector 420, an operational amplifier 430, a compensation circuit 440, and a reference current generator 450. The current mirror 410 is connected among a power supply voltage line VDD, a first node N1, and a second node N2 and includes a pair of first-conductivity-type transistors MP1 and MP2. The transistors MP1 and MP2 are controlled responsive to an output voltage of the operational amplifier 430. The transistors MP1 and MP2 are matching transistors having the same size.

The voltage detector 420 is connected among the first node N1, the second node N2, and a ground voltage line VSS and generates a first input voltage V+ and a second input voltage V− based on a voltage level of the first node N1 and a voltage level of the second node N2, respectively. The voltage detector 420 includes a first voltage detection circuit 422 and a second voltage detection circuit 424.

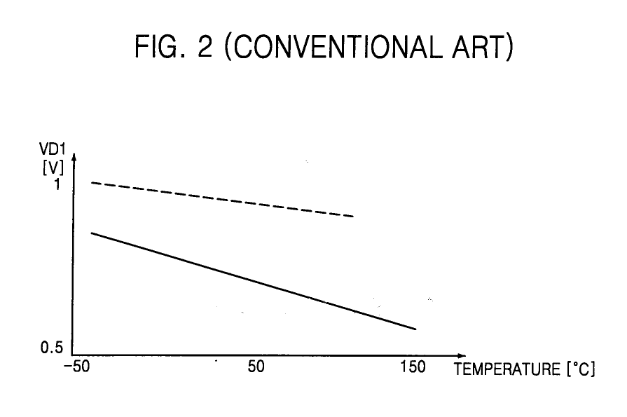

The first voltage detection circuit 422 includes a first diode D1 connected between the first node N1 and the ground voltage line VSS and a first voltage dividing circuit. The first voltage dividing circuit includes a plurality of resistors R1, R2, and R3 connected in series between the first node N1 and the ground voltage line VSS. The first input voltage V+ results from dividing the voltage of the first node N1 by the plurality of resistors R1, R2, and R3 and thus reflects a voltage variation of the first diode D1, which means that the level of the first input voltage V+ increases when the voltage level of the first diode D1 increases and decreases when the voltage level of the first diode D1 decreases. The voltage level of the first diode D1 may change at different rates with respect to temperature according to a process variation, as illustrated in FIG. 2. Consequently, the voltage level of the first diode D1 may vary with the temperature and the process variation.

The second voltage detection circuit 424 includes a resistor R7 and a second diode D2 connected in series between the second node N2 and the ground voltage line VSS and a second voltage dividing circuit. The second voltage dividing circuit includes a plurality of resistors R4, R5, and R6 connected in series between the second node N2 and the ground voltage line VSS. Each of the first and second diodes D1 and D2 may be implemented by a diode-connected transistor (e.g., a bipolar transistor).

The resistor R7 functions to equalize the voltage of the second node N2 with the voltage of the first node N1. The second input voltage V− results from dividing the voltage of the second node N2 by the plurality of resistors R4, R5, and R6 and thus reflects a voltage variation of the second diode D2. The voltage of the second diode D2 may also change at different rates with respect to temperature according to a process variation and thus vary with the temperature and the process variation. Each of the resistors R4, R5, and R6 of the second voltage dividing circuit may have the same resistance value as a corresponding resistor R1, R2, or R3, respectively, of the first voltage dividing circuit. For example, the resistors R1 and R4 may have the same resistance value; the resistor R2 and R5 may have the same resistance value; and the resistor R3 and R6 may have the same resistance value.

The resistance values of the resistors R1 through R6 in the first and second voltage dividing circuits and voltage detection nodes ND1 and ND2 may be set such that the first input voltage V+ and the second input voltage V− have the same level. The first input voltage V+ and the second input voltage V− may be set such that the operational amplifier 430 operates in a saturation region.

The operational amplifier 430 includes a first input terminal (+) receiving the first input voltage V+, a second input terminal (−) receiving the second input voltage V−, and an output terminal connected to a common gate of the transistors MP1 and MP2.

If the compensation circuit 440 does not operate, the operational amplifier 430 receives the first input voltage V+reflecting the voltage variation of the first diode D1 and the second input voltage V− reflecting the voltage variation of the second diode D2. As a result, the reference current Iref generated by the reference current generator 450 responsive to the output voltage of the operational amplifier 430 also varies with the temperature and/or the process variation. The compensation circuit 440 detects the voltage of the first node N1, outputs a control signal CS based on the detected first node voltage VD1, and compensates for the variation of the first node voltage VD1 responsive to the control signal CS.

The compensation circuit 440 includes a control signal generator 442 and a voltage compensator 444. The compensation circuit 440 may further include a dummy control signal generator (not shown) connected to the second node N2 to balance the load between the first node N1 and the second node N2. In this case, the dummy control signal generator is just for the load balance and does not influence the operation of the voltage compensator 444.

The control signal generator 442 may generate the control signal CS by detecting the first node voltage VD1 and stepping down the first node voltage VD1. In other words, the control signal generator 442 may be implemented by a step-down circuit which reduces a received voltage and outputs a reduced voltage. The voltage compensator 444 changes the resistance value of the first and second voltage dividing circuits responsive to the control signal CS.

The control signal CS changes the resistance value of the first and second voltage dividing circuits so as to decrease the level of the first input voltage V+ and the level of the second input voltage V− when the first node voltage VD1 increases and to increase the level of the first and second input voltages V+ and V− when the first node voltage VD1 decreases.

The voltage compensator 444 includes a first transistor MN1 and a second transistor MN2. The first and second transistors MN1 and MN2 may be NMOS transistors, and may also be matching transistors. The first transistor MN1 may be connected in parallel with at least one resistor R2 among the resistors R1 through R3 of the first voltage dividing circuit and has a resistance value varying responsive to the control signal CS. The second transistor MN2 may be connected in parallel with at least one resistor R5 among the resistors R4 through R6 of the second voltage dividing circuit and has a resistance value varying responsive to the control signal CS. The first and second transistors MN1 and MN2 may have the same resistance value.

As described above, the first and second transistors MN1 and MN2 operate as variable resistors, and therefore, persons with skill in the art will recognize they may be replaced with other elements that have a resistance value varying responsive to the control signal CS.

The voltage compensator 444 illustrated in FIG. 4 includes only one pair of variable resistors, but it may include at least one more pair of variable resistors, which have a resistance value varying responsive to the control signal CS and are respectively connected in parallel with a resistor of the first voltage dividing circuit and a corresponding resistor of the second voltage dividing circuit.

Alternatively, the compensation circuit 440 may detect the first node voltage VD1, output the control signal CS based on a result of comparing the first node voltage VD1 with a predefined voltage, and compensate for the variation of the first node voltage VD1. At this time, the control signal generator 442 may detect the first node voltage VD1 and output the control signal CS based on the result of comparing the first node voltage VD1 with the predefined voltage. The control signal generator 442 may be implemented by a comparator. The predefined voltage may be selected such that when the first diode D1 and the second diode D2 are high diode voltage models, the logic level of the control signal CS is different from that when the first diode D1 and the second diode D2 are low diode voltage models. In this case, the control signal generator 442 may output the control signal CS at a high level when the first and second diodes D1 and D2 are the high diode voltage models and may output the control signal CS at a low level when the first and second diodes D1 and D2 are the low diode voltage models.

The voltage compensator 444 may include the first transistor MN1 and the second transistor MN2. The first transistor MN1 may be connected in parallel with at least one resistor R2 among the resistors R1 through R3 of the first voltage dividing circuit and is controlled responsive to the control signal CS. The second transistor MN2 may be connected in parallel with at least one resistor R5 among the resistors R4 through R6 of the second voltage dividing circuit and is controlled responsive to the control signal CS. The first and second transistors MN1 and MN2 may function as switching elements that are turned on when the control signal CS is at the high level and turned off when the control signal CS is at the low level. Accordingly, the first and second transistors MN1 and MN2 may be implemented by switching elements controlled responsive to the control signal CS.

The reference current generator 450 generates the reference current Iref responsive to the output voltage of the operational amplifier 430. The reference current generator 450 may include a first-conductivity-type transistor MP3 that is connected with the power supply voltage line VDD and controlled by the output voltage of the operational amplifier 430.

Hereinafter, a procedure for compensating for a diode voltage variation caused by the change in a diode model in the reference bias circuit 400 so as to prevent the change in the reference current Iref will be described.

When the first and second diodes D1 and D2 are low diode voltage models, the level of the first node voltage VD1 and the level of the control signal CS decrease. As a result, the first and second transistors MN1 and MN2 of the voltage compensator 444 may operate in a region (e.g., a linear region or a cut-off region) having a high impedance. Conversely, when the first and second diodes D1 and D2 are high diode voltage models, the level of the first node voltage VD1 of the first node N1 and the level of the control signal CS increase. As a result, the first and second transistors MN1 and MN2 of the voltage compensator 444 may operate in a region (e.g., a saturation region) having a low impedance.

First, it will be described how the reference bias circuit 400 operates when the first and second diodes D1 and D2 are high diode voltage models in a state where the first input voltage V+ and the second input voltage V− are optimized to low diode voltage models. In this case, the level of the first node voltage VD1 and the level of the second node voltage VD2 increase, and therefore, the level of the first input voltage V+ and the level of the second input voltage V− is higher than those when the first and second diodes D1 and D2 are low diode voltage models.

Assuming a case where the control signal generator 442 steps down the first node voltage VD1 so as to generate the control signal CS in the reference bias circuit 400, the control signal generator 442 generates the control signal CS at a higher voltage level when the first and second diodes D1 and D2 are high diode voltage models than when the first and second diodes D1 and D2 are low diode voltage models.

When the first and second diodes D1 and D2 are low diode voltage models, the transistors MN1 and MN2 of the voltage compensator 444 may operate in the linear region having the high impedance. Conversely, when the first and second diodes D1 and D2 are high diode voltage models, the transistors MN1 and MN2 of the voltage compensator 444 may operate in the saturation region having the low impedance responsive to the control signal CS. As a result, when the first and second diodes D1 and D2 are high diode voltage models, resistance ratios used to generate the first input voltage V+ and the second input voltage V− from the first node voltage VD1 and the second node voltage VD2 through dividing are lowered. Specifically, a ratio between the resistance value of the resistor R1 and the sum of the parallel resistance value of the first transistor MN1, the resistance value of the resistor R2, and the resistance of the resistor R3 decreases, and therefore, the increment of the first node voltage VD1 can be compensated for. Also, a ratio between the resistance value of the resistor R4 and the sum of the parallel resistance value of the second transistor MN2, the resistance value of the resistor R5, and the resistance of the resistor R6 decreases, and therefore, the increment of the second node voltage VD2 can be compensated for.

Another case where the control signal generator 442 outputs the control signal CS based on the result of comparing the first node voltage VD1 with the predefined voltage in the reference bias circuit 400 will be described below.

The control signal generator 442 outputs the control signal CS at the high level. When the first and second diodes D1 and D2 are low diode voltage models, the first and second transistors MN1 and MN2 of the voltage compensator 444 may be turned off responsive to the control signal CS at the low level. When the first and second diodes D1 and D2 are high diode voltage models, the first and second transistors MN1 and MN2 of the voltage compensator 444 may be turned on responsive to the control signal CS at the high level. As a result, when the first and second diodes D1 and D2 are high diode voltage models, resistance ratios used to generate the first input voltage V+ and the second input voltage V− from the first node voltage VD1 and the second node voltage VD2 through dividing are lowered. Consequently, the increment of the first and second node voltages VD1 and VD2 can be compensated for.

Second, it will be described how the reference bias circuit 400 operates when the first and second diodes D1 and D2 are low diode voltage models in a state where the first input voltage V+ and the second input voltage V− are optimized to high diode voltage models. In this case, the level of the first node voltage VD1 and the level of the second node voltage VD2 decrease, and therefore, the level of the first input voltage V+ and the level of the second input voltage V− is lower than those when the first and second diodes D1 and D2 are high diode voltage models.

Assuming a case where the control signal generator 442 steps down the first node voltage VD1 so as to generate the control signal CS in the reference bias circuit 400, the control signal generator 442 generates the control signal CS at a lower voltage level when the first and second diodes D1 and D2 are low diode voltage models than when the first and second diodes D1 and D2 are high diode voltage models.

When the first and second diodes D1 and D2 are high diode voltage models, the transistors MN1 and MN2 of the voltage compensator 444 may operate in the saturation region having the low impedance. Conversely, when the first and second diodes D1 and D2 are low diode voltage models, the transistors MN1 and MN2 of the voltage compensator 444 may operate in the linear region having the high impedance responsive to the control signal CS. As a result, when the first and second diodes D1 and D2 are low diode voltage models, resistance ratios used to generate the first input voltage V+ and the second input voltage V− from the first node voltage VD1 and the second node voltage VD2 through dividing are raised. Specifically, a ratio between the resistance value of the resistor R1 and the sum of the parallel resistance value of the first transistor MN1, the resistance value of the resistor R2, and the resistance of the resistor R3 increases, and therefore, the decrement of the first node voltage VD1 can be compensated for. Also, a ratio between the resistance value of the resistor R4 and the sum of the parallel resistance value of the second transistor MN2, the resistance value of the resistor R5, and the resistance of the resistor R6 increases, and therefore, the decrement of the second node voltage VD2 can be compensated for.

Another case where the control signal generator 442 outputs the control signal CS based on the result of comparing the first node voltage VD1 with the predefined voltage in the reference bias circuit 400 will be described below.

The control signal generator 442 outputs the control signal CS at the low level. When the first and second diodes D1 and D2 are high diode voltage models, the first and second transistors MN1 and MN2 of the voltage compensator 444 may be turned on responsive to the control signal CS at the high level. When the first and second diodes D1 and D2 are low diode voltage models, the first and second transistors MN1 and MN2 of the voltage compensator 444 may be turned off responsive to the control signal CS at the low level. As a result, when the first and second diodes D1 and D2 are low diode voltage models, resistance ratios used to generate the first input voltage V+ and the second input voltage V− from the first node voltage VD1 and the second node voltage VD2 through dividing are raised. Consequently, the decrement of the first and second node voltages VD1 and VD2 can be compensated for. Accordingly, the level of the first and second input voltages V+ and V− can be maintained nearly constant or within a predefined range.

As described above, the compensation circuit 440 decreases the level of the first and second input voltages V+ and V− when the voltage level of the first and second nodes N1 and N2 is increased and increases the level of the first and second input voltages V+ and V− when the voltage level of the first and second nodes N1 and N2 is decreased, so that the first and second input voltages V+ and V− can be maintained within a predefined range and the output voltage of the operational amplifier 430 is prevented from varying. This operation consequently prevents the reference current Iref from varying because the reference current Iref is generated responsive to the output voltage of the operational amplifier 430.

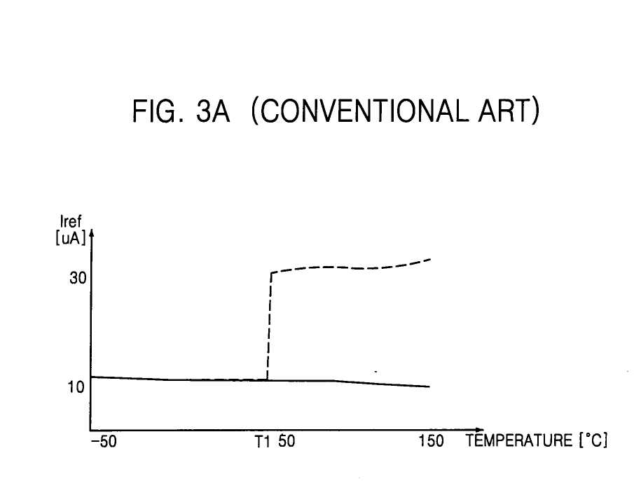

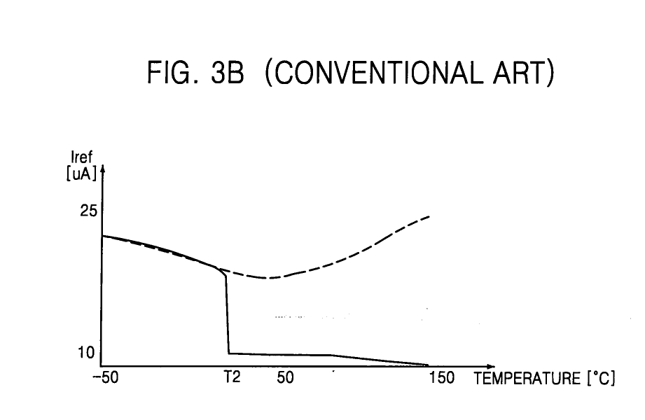

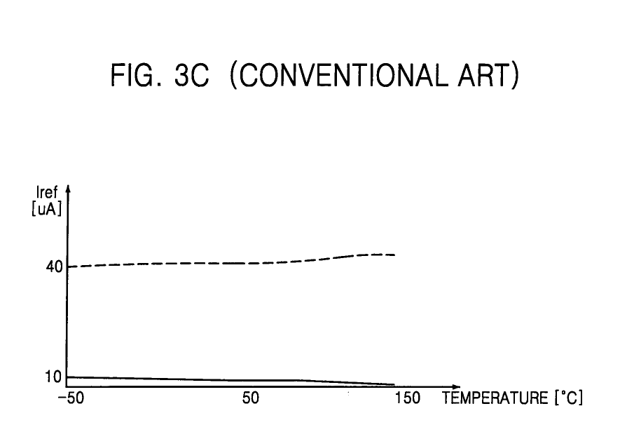

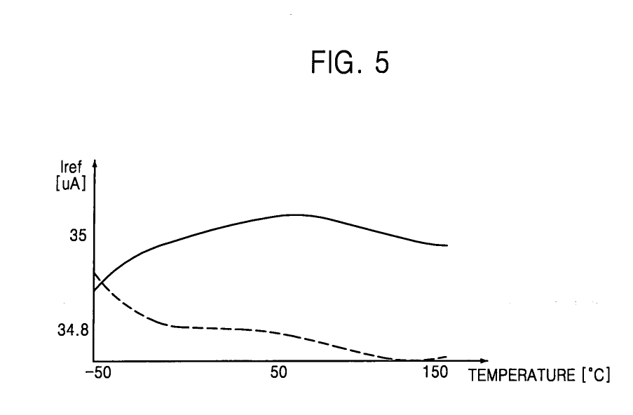

FIG. 5 is a graph of the reference current Iref generated in the reference voltage generation circuit 400 illustrated in FIG. 4 versus temperature with respect to different diode models. Referring to FIGS. 3A through 3C, the reference current Iref in the conventional reference bias circuit 100 may change with a difference of several tens of μA according to diode models. However, in the reference bias circuit 400 according to the present invention, the reference current Iref changes with a difference of only 1 μA according to diode models.

The embodiments described above mainly relate to a reference current generation circuit, but those with skill in the art will recognize that the present invention can also be applied to reference voltage generation circuits. In other words, a reference bias circuit according to the present invention can be widely used in semiconductor devices or other electronic devices that require a reference current or a reference voltage.

According to embodiments of the present invention, the change of diode characteristics (e.g., voltage characteristics), which may be caused by process variation, is compensated for so that the variation of reference current or voltage in a reference bias circuit including diodes can be prevented or reduced. As a result, the reference bias circuit is more independent of the process variation.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A reference bias circuit comprising:
a current mirror comprising a pair of first-conductivity-type transistors which are connected among a power supply voltage line, a first node, and a second node and have a common gate;
a voltage detector connected among the first node, the second node, and a ground voltage line and configured to generate a first input voltage and a second input voltage based on a voltage level of the first node and a voltage level of the second node, respectively;
an operational amplifier comprising a first input terminal configured to receive the first input voltage, a second input terminal configured to receive the second input voltage, and an output terminal connected to the common gate of the pair of the transistors; and
a compensation circuit configured to compensate for a voltage variation of the first node responsive to a control signal generated based on the voltage level of the first node.

2. The reference bias circuit of claim 1, further comprising a reference current generator configured to generate a reference current responsive to an output voltage of the operational amplifier.

3. The reference bias circuit of claim 2, wherein the reference current generator comprises a first-conductivity-type transistor, which is connected to the power supply voltage line and is controlled by the output voltage of the operational amplifier.

4. The reference bias circuit of claim 1, wherein the voltage detector comprises:
a first voltage detection circuit connected between the first node and the ground voltage line to generate the first input voltage by dividing the voltage level of the first node; and
a second voltage detection circuit connected between the second node and the ground voltage line to generate the second input voltage by dividing the voltage level of the second node.

5. The reference bias circuit of claim 4, wherein the first voltage detection circuit comprises:
a first diode connected between the first node and the ground voltage line; and
a first voltage dividing circuit comprising a plurality of resistors connected in series between the first node and the ground voltage line.

6. The reference bias circuit of claim 5, wherein the second voltage detection circuit comprises:
a resistor and a second diode connected in series between the second node and the ground voltage line; and
a second voltage dividing circuit comprising a plurality of resistors connected in series between the second node and the ground voltage line.

7. The reference bias circuit of claim 6, wherein the compensation circuit comprises:
a control signal generator configured to generate the control signal by detecting the voltage level of the first node and stepping down the voltage level of the first node; and
a voltage compensator configured to change a resistance value of the first and second voltage dividing circuits responsive to the control signal.

8. The reference bias circuit of claim 7, wherein the voltage compensator comprises:
a first variable resistor connected in parallel to at least one resistor among the plurality of resistors of the first voltage dividing circuit and configured to have a resistance value which varies responsive to the control signal; and
a second variable resistor connected in parallel to at least one resistor among the plurality of resistors of the second voltage dividing circuit and configured to have a resistance value which varies responsive to the control signal.

9. The reference bias circuit of claim 6, wherein the compensation circuit comprises:
a control signal generator configured to detect the voltage level of the first node and to generate the control signal based on a result of comparing the detected voltage level of the first node with a predefined voltage; and
a voltage compensator configured to change a resistance value of the first and second voltage dividing circuits responsive to the control signal.

10. The reference bias circuit of claim 9, wherein the voltage compensator comprises:
a first switching element connected in parallel to at least one resistor among the plurality of resistors of the first voltage dividing circuit and configured to be controlled responsive to the control signal; and
a second switching element connected in parallel to at least one resistor among the plurality of resistors of the second voltage dividing circuit and configured to be controlled responsive to the control signal.

11. The reference bias circuit of claim 7, wherein the compensation circuit further comprises a dummy control signal generator which is connected to the second node and functions as a load on the second node to balance a load between the first node and the second node.

12. The reference bias circuit of claim 9, wherein the compensation circuit further comprises a dummy control signal generator which is connected to the second node and functions as a load on the second node to balance a load between the first node and the second node.

13. A reference bias circuit comprising:
a current mirror connected among a power supply voltage line, a first node, and a second node;
a voltage detector configured to output a first input voltage and a second input voltage by dividing a voltage of the first node and a voltage of the second node by a plurality of resistors;
an operational amplifier configured to amplify a difference between the first input voltage and the second input voltage and to output the result of the amplification to the current mirror; and
a compensation circuit configured to compensate for a voltage variation of the first node responsive to a control signal generated based on the voltage of the first node.

14. The reference bias circuit of claim 13, wherein the compensation circuit is configured to vary a resistance value of at least one pair of resistors among the plurality of resistors.

15. The reference bias circuit of claim 13, wherein the voltage detector comprises:
a first voltage detection circuit configured to detect the voltage of the first node;
a first voltage dividing circuit configured to divide the voltage of the first node using a plurality of first resistors with respect to a ground voltage;
a second voltage detection circuit configured to detect the voltage of the second node; and
a second voltage dividing circuit configured to divide the voltage of the second node using a plurality of second resistors with respect to the ground voltage.

16. The reference bias circuit of claim 15, wherein the compensation circuit comprises:
a control signal generator configured to generate the control signal by detecting the voltage of the first node and stepping down the first node voltage; and
a voltage compensator configured to change a resistance value of at least one resistor among the first resistors and a resistance value of at least one resistor among the second resistors responsive to the control signal.

17. The reference bias circuit of claim 16, wherein the voltage compensator comprises:
a first variable resistor connected in parallel to at least one resistor among the first resistors and having a resistance value which varies responsive to the control signal; and
a second variable resistor connected in parallel to at least one resistor among the second resistors and having a resistance value which varies responsive to the control signal.

18. The reference bias circuit of claim 15, wherein the compensation circuit comprises:
a control signal generator configured to detect the voltage of the first node and to generate the control signal based on a result of comparing the detected first node voltage with a predefined voltage; and
a voltage compensator configured to change a resistance value of at least one resistor among the first resistors and a resistance value of at least one resistor among the second resistors responsive to the control signal.

19. The reference bias circuit of claim 18, wherein the voltage compensator comprises:
a first switching element connected in parallel to at least one resistor among the first resistors and controlled responsive to the control signal; and
a second switching element connected in parallel to at least one resistor among the second resistors and controlled responsive to the control signal.

20. A semiconductor device comprising:
a reference bias circuit comprising:
a current mirror comprising a pair of first-conductivity-type transistors which are connected among a power supply voltage line, a first node, and a second node and have a common gate;
a voltage detector connected among the first node, the second node, and a ground voltage line and configured to generate a first input voltage and a second input voltage by dividing a voltage level of the first node and a voltage level of the second node by a first plurality of resistors and a second plurality of resistors, respectively;
an operational amplifier comprising a first input terminal configured to receive the first input voltage, a second input terminal configured to receive the second input voltage, and an output terminal connected to the common gate of the pair of the transistors;
a reference current generator configured to generate a reference current responsive to an output voltage of the operational amplifier; and
a compensation circuit configured to compensate for a voltage variation of the first node responsive to a control signal generated based on the voltage level of the first node,
wherein the compensation circuit is configured to vary a resistance value of one pair of resistors among the first plurality of resistors, and of another pair of resistors among the second plurality of resistors, thereby preventing a variation of the reference current generated by the reference current generator.
